(19) United States
(12) Patent Application Publication
(10) Pub. No.: US 2024/0376908 A1
(43) Pub. Date: Nov. 14, 2024

(54) Centrifugal Fan Impeller, Fan and Air Conditioning System

(71) Applicant: Gree Green Refrigeration Technology Center Co., Ltd. of Zhuhai, Zhuhai, Guangdong (CN)

(72) Inventors: Hui Du, Zhuhai, Guangdong (CN); Hua Liu, Zhuhai, Guangdong (CN); Jiangcheng Zhu, Zhuhai, Guangdong (CN); Cheng Zeng, Zhuhai, Guangdong (CN); Boqiang Chen, Zhuhai, Guangdong (CN)

(21) Appl. No.: 18/289,954

(22) PCT Filed: May 26, 2022
(86) PCT No.: PCT/CN2022/095174

§ 371 Date: Nov. 8, 2023

(30) Foreign Application Priority Data
Aug. 4, 2021 (CN) 202110889437.5

(51) Int. Cl. F04D 29/66; F04D 25/08

(52) U.S. Cl. CPC F04D 29/666; F04D 17/162; F04D 25/08; F04D 29/283; F05D 2240/301

(57) ABSTRACT

The present disclosure provides a centrifugal fan impeller, a fan, and an air conditioning system, which solve the technical problems of a small air volume and large noise of a centrifugal fan, low efficiency of a fan, and a relatively concentrated airflow. The centrifugal fan impeller includes blades and a fixing disk, the blades being forward-curved structures and fixed to the fixing disk, wherein in a height direction of the blades, widths of all or part of the blades progressively increase from a suction port to the fixing disk, so that the suction port of the fan impeller is a tapering trumpet-like structure. The fan includes a centrifugal fan impeller, and a volute, which is inclined on two sides. The air conditioning system includes a fan. The suction port of the fan impeller of the present disclosure is configured as a trumpet-like tapering structure, such that an air intake area of the fan impeller is increased, air intake resistance is reduced, and an air volume and efficiency of the fan are improved, under the condition of the same outer diameter and height of the fan impeller; intake angles of the blades change, thereby effectively discretizing intake fluid and reducing noise; and the width of the fan impeller progressively increases, and the work capacity of the fan impeller gradually increases, thus improving the overall work efficiency of the fan.

### CROSS-REFERENCE TO RELATED APPLICATIONS

This application is the United States national phase of International Patent Application No. PCT/CN2022/095174, filed May 26, 2022, and claims priority to Chinese Patent Application No. 202110889437.5, filed Aug. 4, 2021, the disclosures of which are hereby incorporated by reference in their entireties.

### BACKGROUND OF THE INVENTION

### Field of the Invention

The present disclosure relates to the field of air conditioning technology, in particular, to a centrifugal fan impeller, a fan and an air conditioning system including the same.

### Description of Related Art

As shown in FIG. 1, a forward-curved (a bent direction of an air outlet of a fan impeller is same as a direction in which the fan impeller rotates to do work) fan system including a centrifugal fan impeller and a volute has the following problems:

1. For a traditional centrifugal fan impeller, as shown in FIGS. 1 and 2, if individual blades 1 have a certain outer diameter, to increase the air volume of a unit, the work height of the blades 1 may be increased, but in this case, the area of a suction port of a fan becomes a constraining factor for the fan. Directly increasing an inner diameter can lead to a reduced work area of the fan impeller (multiplying the width of each blade by its height yields a work area), thereby leading to reduced work capacity of the fan impeller, such that the purpose of increasing the air volume cannot achieved, resulting in a low air volume and low efficiency of the traditional centrifugal fan.

2. The fan impeller is featured by an equal inner diameter in its height direction, intake angles of the fan impeller are same, and frequencies of fluid entering the fan impeller are similar, resulting in large noise when the fan impeller operates.

3. If the height of the fan impeller is large, due to the same work capacity of the fan impeller, negative pressures at positions on the fan impeller close to the inner side are large, so effective suction is difficult on the inner side, resulting in low work efficiency of the whole fan impeller.

The three points as described above result in a small air volume and large noise of the fan system and low efficiency of the fan.

### SUMMARY OF THE INVENTION

An object of the present disclosure is to provide a centrifugal fan impeller, a centrifugal volute, a fan, and an air conditioning system including the same, so as to solve the technical problems of a small air volume and large noise of a centrifugal fan and low efficiency of a fan in technology known to the inventors.

To achieve the above object, the present disclosure provides the following technical solution:

The present disclosure provides a centrifugal fan impeller, including blades and a fixing disk, the blades being forward-curved structures and fixed to the fixing disk, wherein in a height direction of the blades, widths of all or part of the blades progressively increase from a suction port to the fixing disk, so that the suction port of the fan impeller is a tapering trumpet-like structure.

In some embodiments, intake sides of some or all of the blades are arranged inclined relative to an axial direction of the fixing disk.

In some embodiments, the inclinations of the intake sides of the blades relative to the axial direction of the fixing disk are set differently or identically.

In some embodiments, in the height direction of the blades, intake angle angles of the blades change continuously from the suction port towards the fixing disk.

In some embodiments, the continuous changes of the intake angles of the blades are continuous increases.

In some embodiments, a maximum value φ2 of the intake angles of the blades is: φ2=φ1+H×Y, where φ1 is a minimum value of the intake angles of the blades, H is a height of the blades, and Y is a second coefficient, wherein 1 degree/mm≥Y≥0.04 degree/mm.

In some embodiments, a range of the second coefficient Y is 0.2 degree/mm≤Y≤0.5 degree/mm.

In some embodiments, a diameter D1 of a maximum inscribed circle of the suction port of the centrifugal fan impeller perpendicular to an axis is: D1=D2+H×X, where D2 is a diameter of a minimum inscribed circle of the suction port of the centrifugal fan impeller perpendicular to the axis, H is the height of the blades, and X is a first coefficient, wherein 0.35≥X≥0.02.

In some embodiments, a range of the first coefficient is 0.07≤X≤0.2.

In some embodiments, outlet angles β of the blades are in the range of: 5°≤β≤40°.

In some embodiments, the outlet angles β of the blades are in the range of 13°≤β≤24°.

In some embodiments, the centrifugal fan impeller is a structure with blades on one side or a structure with blades on two sides, wherein in the case of a structure with blades on two sides, the blades on the two sides are staggered.

In some embodiments, the centrifugal fan impeller further includes second blades provided on the fixing disk and located on an inner side of the blades.

In some embodiments, the centrifugal fan impeller further includes a reinforcing ring located at an end of an outlet side of the blades, the reinforcing ring being a ring-like structure.

The present disclosure provides a fan, including a volute and the centrifugal fan impeller, wherein the volute collects and directs an outflow from the centrifugal fan impeller and then discharges the outflow via an outflow port.

In some embodiments, the volute is a structure inclined on one side or a structure inclined on two sides.

In some embodiments, in the case where the volute is a structure inclined on one side, 0.7≤L1/L2≤0.99; and in the case where the volute is a structure inclined on two sides, 0.6≤L1/L2≤0.98, where L1 is a minimum distance between the two sides of the volute, and L2 is a maximum distance between the two sides of the volute.

In some embodiments, two endpoints of the minimum distance L1 on the two sides of the volute are located in an obtuse-angle sector area formed by three elements: a volute tongue, a circle center of an inflow port of the volute and a tail end of an involute of the volute; and two endpoints of the maximum distance L2 on the two sides of the volute are located in a sector area formed by three elements: the tail end of the involute of the volute, the circle center of the inflow port of the volute, and a distal end of the outflow port on the side of the volute tongue.

In some embodiments, the volute tongue of the volute is a flat volute tongue or an inclined volute tongue; in the case where the volute tongue is a flat volute tongue, a length direction of the volute tongue is parallel to an axial direction of the centrifugal fan impeller; and in the case where the volute tongue is an inclined volute tongue, an included angle is formed between the length direction of the volute tongue and the axial direction of the centrifugal fan impeller.

In some embodiments, the volute tongue is a structure inclined on one side or inclined on two sides.

In some embodiments, the volute is a one-piece structure or a split structure, and in the case where the volute is a split structure composed of a plurality of units of the volute, neighboring units of the volute are connected to each other by limiting locking structures.

In some embodiments, the volute is provided with a partial removal portion.

The present disclosure provides an air conditioning system, which includes the fan and a heat exchanger.

Compared with technology known to the inventors, the present disclosure has the following beneficial effects:
In the centrifugal fan impeller provided in the present disclosure, the suction port of the fan impeller is configured as a trumpet-like tapering structure, such that an air intake area of the fan impeller is increased, air intake resistance is reduced, and an air volume and efficiency of the fan are improved, under the condition of the same outer diameter and height of the fan impeller; in the height direction of the fan impeller, the intake angles of the blades change continuously from the suction port towards the fixing disk, thereby effectively discretizing intake fluid and reducing noise; and in the height direction of the fan impeller, from the suction port to the fixing disk, the width of the fan impeller progressively increases, and the work capacity of the fan impeller gradually increases, thus improving an average work capacity in the height direction of the entire fan impeller, and increasing the overall work efficiency of the fan. In the fan provided in the present disclosure, the tilted volute is used to further increase an air intake channel, reduce air intake resistance, increase the air volume, and reduces noise; moreover, the tilted volute may also expand outflow fluid, so that an airflow is blown more uniformly to a heat exchanger, thereby improving the heat exchange amount of an air conditioning unit and reducing the power of the unit.

### BRIEF DESCRIPTION OF THE DRAWINGS

To more clearly describe technical solutions in the embodiments of the present disclosure or in technology known to the inventors, a brief introduction to the drawings for use in description of the embodiments or the technology known to the inventors will be given below. Obviously, the drawings in the following description only illustrate some embodiments of the present disclosure, and other drawings may also be obtained by those of ordinary skill in the art based on the drawings without creative work.

FIG. 1 is a schematic structural diagram of a centrifugal fan impeller of technology known to the inventors as viewed from a suction port side;

FIG. 2 is a schematic structural diagram of a centrifugal fan impeller of technology known to the inventors as viewed from an air outlet side;

FIG. 3 is a schematic structural diagram of a centrifugal fan impeller of the present disclosure as viewed from a suction port side;

FIG. 4 is a partial enlarged view of A in FIG. 3.

FIG. 5 is a schematic structural diagram of a centrifugal fan impeller of the present disclosure, which is a single side fan impeller, as viewed from an air outlet side;

FIG. 6 is a schematic structural diagram of a centrifugal fan impeller of the present disclosure, which is a double side fan impeller, as viewed from an air outlet side;

FIG. 7 is a schematic structural diagram of a centrifugal fan impeller of the present disclosure with blades being partially removed;

FIG. 8 is a schematic structural diagram of a centrifugal fan impeller of the present disclosure in which a suction port side of part of the fan impeller is inclined;

FIG. 9 is a schematic structural diagram of a centrifugal volute of the present disclosure;

FIG. 10 is a schematic structural diagram of a centrifugal volute of the present disclosure which is inclined on two sides;

FIG. 11 is a cross-sectional view along II′ in FIG. 10;

FIG. 12 is a schematic structural diagram of a centrifugal volute of the present disclosure which is inclined on one side;

FIG. 13 is a cross-sectional view along II′ in FIG. 12;

FIG. 14 is a schematic structural diagram of an inclined volute tongue in a centrifugal volute of the present disclosure;

FIG. 15 is an air volume comparison diagram when a centrifugal fan impeller of the present disclosure is applied to a 7.2 KW air duct machine;

FIG. 16 is a noise comparison diagram when a centrifugal fan impeller of the present disclosure is applied to a 7.2 KW air duct machine; and

FIG. 17 is a power comparison diagram when a centrifugal fan impeller of the present disclosure is applied to a 7.2 KW duct machine.

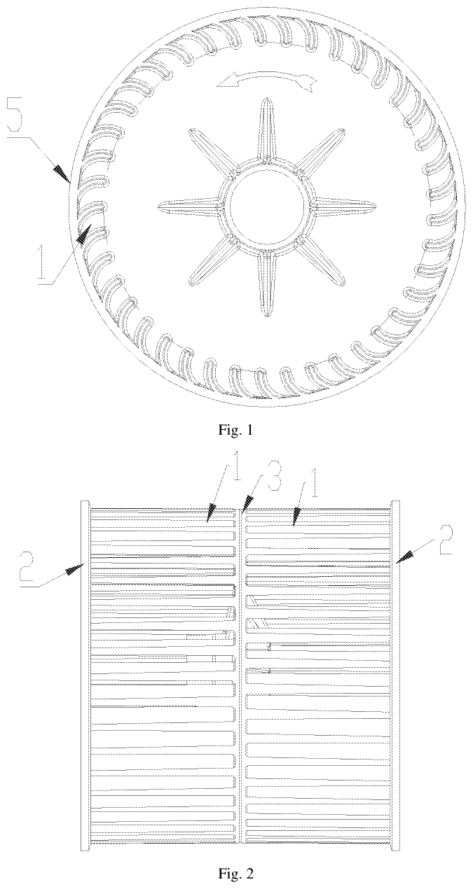

Reference numerals: 1, a blade; 2, a reinforcing ring; 3, fixing disk; 4, second fan impeller; 5, volute; 6, volute tongue; 7, involute segment; 8, first volute; 9, second volute; 10, partial removal portion; 11, a suction port.

### DESCRIPTION OF THE INVENTION

To make the objectives, technical solutions and advantages of the present disclosure clearer, the technical solutions in the present disclosure will be described in detail. Obviously, the embodiments described are part of, rather than all of, the embodiments of the present disclosure. Based on the embodiments in the present disclosure, all other implementations obtained by those of ordinary skill in the art without creative work shall fall within the protection scope of the present disclosure.

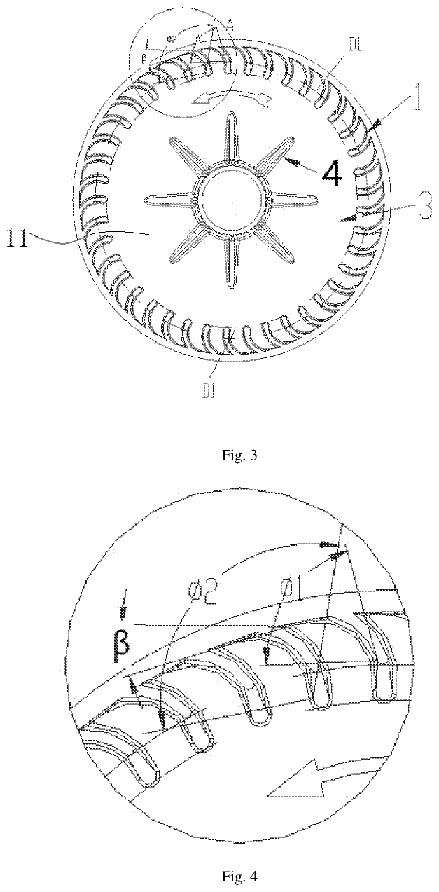

As shown in FIG. 3, the present disclosure provides a centrifugal fan impeller including blades 1 and a fixing disk 3. The blades 1 are forward-curved structures (a bent direction of an air outlet of the fan impeller is same as a direction in which the fan impeller rotates to do work) and are fixed to the fixing disk 3. In a height direction of the blades 1, widths of all or part of the blades 1 progressively increase from a suction port 11 to the fixing disk 3, so that the suction port 11 of the fan impeller is a tapering trumpet-like structure.

It should be noted here that the width of each blade referred to here is a width of the blade 1 in a radial dimension of the fixing disk 3, i.e., in an air outlet direction of an airflow, that is, the farthest distance between two points within a cross-section of the blade 1 cut in a direction parallel to the fixing disk.

In the present disclosure, in the height direction of the fan impeller, from the suction port 11 to the fixing disk, the width of the fan impeller progressively increases, and the work capacity of the fan impeller gradually increases, thus improving an average work capacity in the height direction of the entire fan impeller, and increasing the overall work efficiency of the fan.

It should be noted here that a height of a blade is a height of the blade 1 in an axial direction, that is, a distance of the blade 1 in the direction from the suction port 11 to the fixing disk 3. The suction port 11 is a mouth structure enclosed by one end of each of all the blades 1 away from the fixing disk 3. The airflow enters through the suction port 11, that is, in an axial direction of the centrifugal fan impeller, then turns 90 degrees, and flows out in a radial direction of the centrifugal fan impeller, that is, in a width direction of the fan impeller.

In the centrifugal fan impeller provided in the present disclosure, the suction port 11 of the fan impeller is configured as a trumpet-like tapering structure, such that an air intake area of the fan impeller is increased, air intake resistance is reduced, and an air volume and efficiency of the fan are improved, under the condition of the same outer diameter and height of the fan impeller.

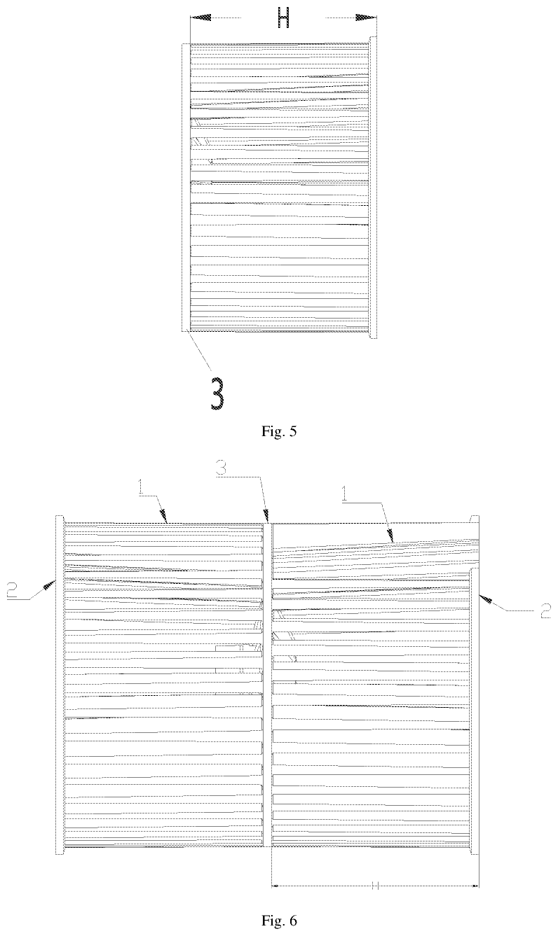

As shown in FIGS. 3, 5, and 6, as an optional implementation of the present disclosure, a diameter D1 of a maximum inscribed circle of the suction port 11 of the centrifugal fan impeller perpendicular to an axis is: D1=D2+H×X, where D2 is a diameter of a minimum inscribed circle of the suction port 11 of the centrifugal fan impeller perpendicular to the axis, H is a height of the blades, and X is a first coefficient, wherein 0.35≥X≥0.02.

Preferably, within the range of the suction port 11 of the fan impeller, a range of the first coefficient is 0.07≤X≤0.2.

As an optional implementation of the present disclosure, in the height direction of the blades 1, intake angles of the blades 1 change continuously from the suction port 11 towards the fixing disk 3.

Further, the continuous changes of the intake angles of the blades 1 described above are continuous increases.

In the present disclosure, in the height direction of the fan impeller, the intake angles of the blades 1 change continuously from the suction port 11 towards the fixing disk, thereby effectively discretizing intake fluid and reducing noise.

As shown in FIGS. 4, 5, and 6, specifically, in this embodiment, a maximum value φ2 of the intake angles of the blades 1 is: φ2=φ1+H×Y, where φ1 is a minimum value of the intake angles of the blades, H is the height of the blades, and Y is a second coefficient, wherein 1 degree/mm≥Y≥0.04 degree/mm. The intake angle of each blade is an included angle between a profile tangent line and a circumferential tangent line of the blade at an inlet of the blade, and if a rounded corner is present at the inlet of the blade, a starting point without the rounded corner is used for the calculation.

A preferred solution is that within the range of intake angles of the blades, a range of the second coefficient Y is 0.2 degree/mm≤Y≤0.5 degree/mm.

As shown in FIGS. 3 and 4, as an optional implementation of the present disclosure, outlet angles β of the blades 1 are in the range of: 5°≤β≤40°. The outlet angle of each blade is an included angle between a profile tangent line and a circumferential tangent line of the blade at an outlet of the blade.

Preferably, the outlet angles β of the blades are in the range of 13°≤β≤24°.

As shown in FIG. 8, as an optional implementation of the present disclosure, intake sides of some or all of the blades 1 are arranged inclined relative to the direction of an axis of the fixing disk 3.

It should be noted here that the intake side of each blade 1 is an innermost side of the blade 1, or in other words, a side of the blade 1 closest to the axis of the fixing disk 3 in a radial direction of the fixing disk 3. The airflow enters through the suction port 11 of the centrifugal fan impeller, then through the intake sides of the blades 1, and then exits through outlet sides of the blades 1.

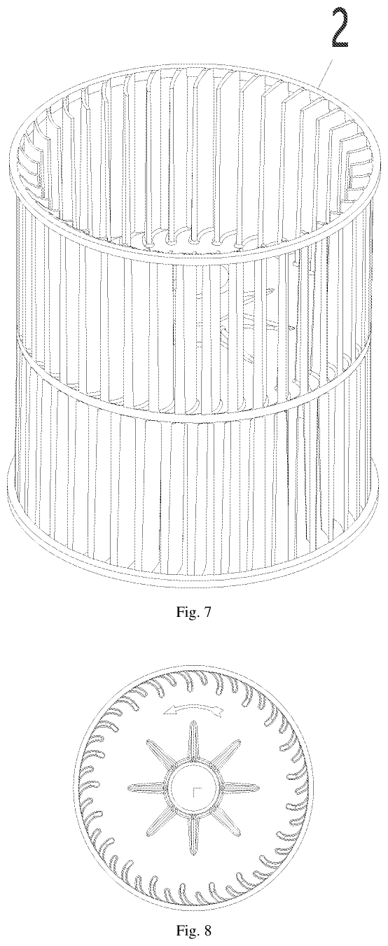

FIG. 6 shows a partial cross-sectional view of one side of the fan impeller.

The blades 1 inclined on the intake sides may be arranged continuously or spaced apart.

As shown in FIG. 8, still further, inclination angles of the intake sides of the blades 1 may be different or same. That is to say, the intake sides of all or part of the blades 1 may be inclined, or the blades may be inclined to different degrees.

It should be noted here that in this embodiment, the centrifugal fan impeller is a structure with blades on one side or a structure with blades on two sides. In the case of a structure with blades on two sides, the blades on the two sides are staggered to reduce noise.

Further, the centrifugal fan impeller further includes second blades 4 provided on the fixing disk 3 and located on an inner side of the blades 1.

As shown in FIG. 7, further, the centrifugal fan impeller further includes a reinforcing ring 2 located at an end of an outlet side of the blades 1. The reinforcing ring 2 is a ring-like structure. If a volute 5 has a certain length, part of the fan impeller on an inner side of the structural reinforcing ring may be removed while increasing the length of the fan impeller and keeping a suitable distance from the volute, to achieve the purpose of increasing a work length of the fan impeller.

A centrifugal fan is often used in parallel or in applications with limitation in a length direction, such as on an air duct machine product. In order to achieve better air intake conditions, it may be used together with an inclined volute. The inclined volute means that a lateral side of the volute is not perpendicular to a rotating shaft of the centrifugal fan and it has a tendency to expand progressively from a suction side toward an air outlet side. This achieves an effect of a greater air volume, lower noise, lower power consumption, and better heat exchange between two devices.

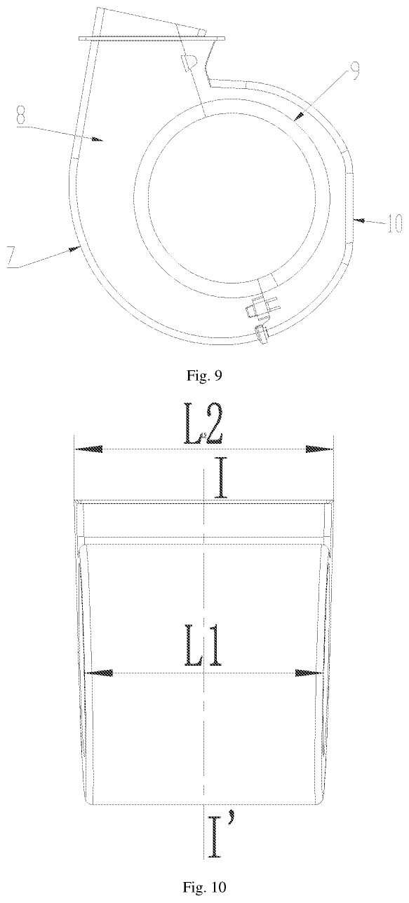

The present disclosure provides a fan, as shown in FIG. 9, including a volute 5 and a centrifugal fan impeller disposed within the volute 5, wherein the volute 5 collects and directs an outflow from the centrifugal fan impeller and then discharges the outflow via an outflow port.

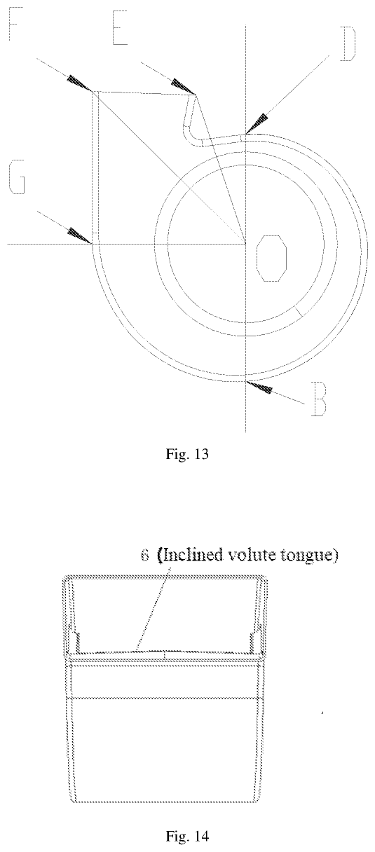

As shown in FIGS. 10 and 12, distances at an intake side of the volute 5 are characterized by a minimum distance L1 between two sides of the volute (except for rounded corners) and a maximum distance L2 between the two sides of the volute, and further, the volute 5 is a structure inclined on one side or a structure inclined on two sides.

The volute 5 is a structure inclined on one side or a structure inclined on two sides.

As shown in FIG. 13, in the case where the volute 5 is a structure inclined on one side, 0.7≤L1/L2≤0.99, preferably 0.85≤L1/L2≤0.96;

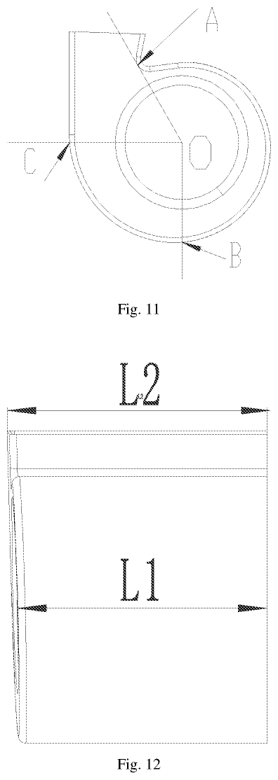

As shown in FIG. 11, in the case where the volute 5 is a structure inclined on two sides, 0.6≤L1/L2≤0.98, preferably 0.8≤L1/L2≤0.95, where L1 is a minimum distance between the two sides of the volute, and L2 is a maximum distance between the two sides of the volute.

As shown in FIGS. 11 and 13, two endpoints of the minimum distance L1 on the two sides of the volute are located in an obtuse-angle sector area formed by three elements: a volute tongue 6, a circle center of an inflow port of the volute and a tail end of an involute of the volute; and two endpoints of the maximum distance L2 on the two sides of the volute are located in a sector area formed by three elements: the tail end of the involute of the volute, the circle center of the inflow port of the volute, and a distal end of the outflow port of the volute tongue.

As shown in FIGS. 11 and 13, specifically, in a narrowest distance projection interval of the intake side of the volute 5: the volute 5 is projected along a middle plane I-I′, an outermost projection J-K of a non-involute segment of the volute 5 is kept vertically upward, and a projection of the two endpoints of the minimum distance L1 on the two sides of the volute is located in a region enclosed by A-O-C (an obtuse angle), where O is a rotation center of the fan impeller (it may also be an intake circle center of the volute if an intake port of the volute is circular), and A is a point of tangency of a tangent line from O to the volute tongue; and C is a point of intersection where a line passing through O perpendicular to J-K intersects with an outermost side of the volute.

In some embodiments, the projection of the two endpoints of the minimum distance L1 on the two sides of the volute is located in a region where A-O-B (an obtuse angle) is located; B is a point of intersection where a line passing through O parallel to J-K intersects with the outermost side of the volute, and the point B is away from the J-K side;

As shown in FIG. 14, the volute tongue is characterized in that: the shape of the volute tongue has an effect on noise, and the volute tongue 6 of the volute 5 is either a flat volute tongue or an inclined volute tongue; in the case where the volute tongue 6 is a flat volute tongue, a length direction of the volute tongue 6 is parallel to the axial direction of the blades 1; and in the case where the volute tongue 6 is an inclined volute tongue, an included angle is formed between the length direction of the volute tongue 6 and the axial direction of the blades 1.

Specifically, in a widest distance projection interval of the intake side of the volute: the volute 5 is projected along the middle plane I-I′, the outermost projection J-K of the non-involute segment of the volute 5 is kept vertically upward, and a projection of the two endpoints of the maximum distance L2 on the two sides of the volute is located in a region enclosed by D-O-C (a right angle), where O is the rotation center of the fan impeller (it may also be the intake circle center of the volute if the intake port of the volute is circular), and D is a point of intersection where a line passing through O parallel to J-K intersects with the outermost side of the volute, and the point D is close to the J-K side; and C is a point of intersection where a line passing through O perpendicular to J-K intersects with the outermost side of the volute.

In some embodiments, the projection of the two endpoints of the maximum distance L2 on the two sides of the volute is located in a region where E-O-C (a right angle) is located, where E is a projection of an outermost side of an outer contour of the volute close to the volute tongue side; and J is a projection of an outermost side of the outer contour of the volute close to the volute tongue side.

Further, the volute tongue 6 is a structure inclined on one side or a structure inclined on two sides towards the middle.

Further, the volute 5 is a one-piece structure or a split structure. In the case where the volute 5 is a split structure composed of a plurality of units of the volute, neighboring units of the volute are connected to each other by limiting locking structures.

Specifically, in order to facilitate installation and disassembly of the fan impeller or a motor, generally the volute is split into a plurality of structures. As shown in FIG. 9, the volute 5 may be split into a first volute 8 and a second volute 9, and the two volutes are provided with snap-fit features therebetween to limit each other, so that the volutes can be assembled together or separated from each other conveniently. Further, the volute 5 may also be split into more than two parts.

The volute is provided with mounting features, which are connected to fasteners to ensure installation reliability.

In order to further reduce a dimension in a thickness direction of an air duct machine, features of the volute 5 may be partially removed to form a partial removal portion 10.

The present disclosure provides an air conditioning system, which includes the above-mentioned fan and a heat exchanger.

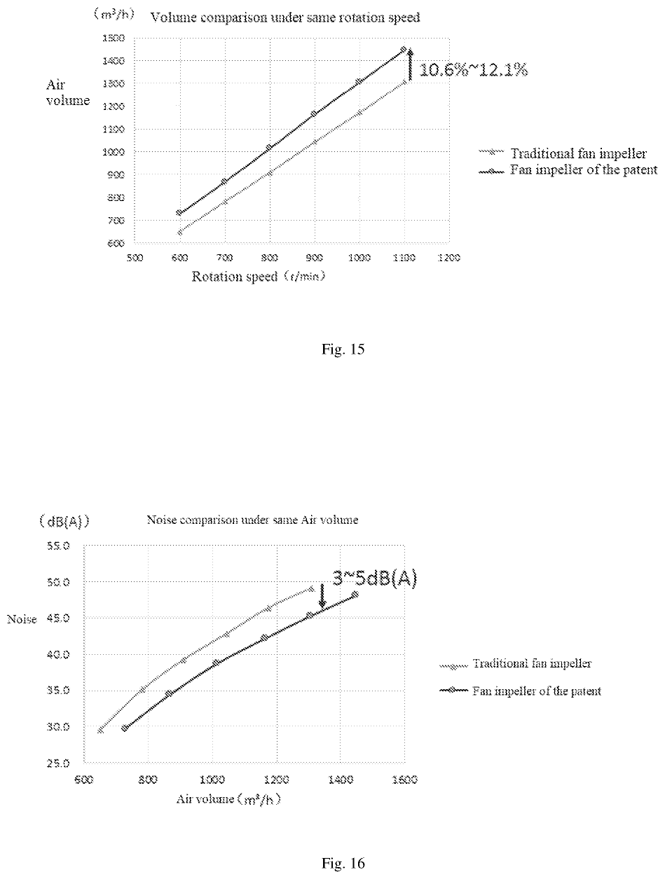

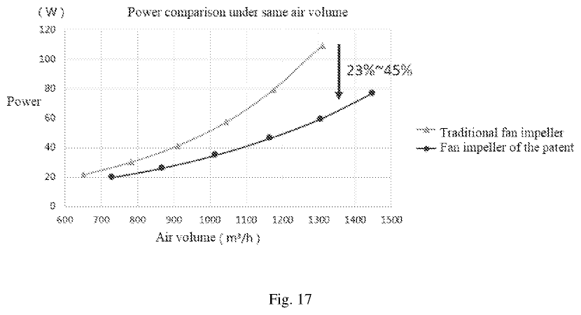

As shown in FIGS. 15 to 17, using an application of the centrifugal fan impeller provided in the present disclosure to a 7.2 kw air duct machine as an example, the unit has a large air volume. The air volume at the same rotation speed is increased by 10.6%-12.1%, the noise at the same air volume is reduced by about 3-5 dB(A), and the efficiency of the fan system is increased by 23%-45%%.

Here, it should be noted first that the term “inward” indicates a direction towards the center of an accommodating space, and the term “outward” indicates a direction away from the center of an accommodating space.

In description of the present disclosure, it needs to be appreciated that orientation or position relations denoted by the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counter-clockwise”, “axial”, “radial”, “circumferential”, and the like are orientation or position relations illustrated based on FIG. 1, and are merely for the convenience of describing the present disclosure and simplifying description, instead of indicating or implying the denoted devices or elements must have specific orientations or be constructed and operated in specific orientations, and thus the terms cannot be construed as limiting the present disclosure.

In addition, the terms “first”, “second” and the like are used only for descriptive purposes and cannot be construed as indicating or implying relative importance or implicitly indicating the numbers of indicated technical features. Thus, a feature qualified by the term “first”, “second” or the like may explicitly or implicitly include at least one such feature. In description of the present disclosure, the term “plurality” means at least two, such as two, three or the like, unless otherwise expressly and specifically defined.

In the present disclosure, unless otherwise clearly specified and defined, the terms “be connected with”, “be connected”, “be fixed” and the like should be understood in a broad sense. For example, it may indicate fixed connection, or detachable connection, or integration; it may indicate mechanical connection, or electrical connection; it may indicate direct connection, or indirect connection through an intermediate medium, or internal communication between two elements or interactive relationship between two elements, unless otherwise clearly defined. For those of ordinary skill in the art, the specific meanings of the above terms in the present disclosure may be understood according to specific circumstances.

In the present disclosure, unless otherwise expressly specified and defined, a first feature being “on” or “under” a second feature may indicate direct contact between the first and second features, or indirect contact between the first and second features through an intermediate feature. Furthermore, a first feature being “on”, “above” or “over” a second feature may indicate the first feature being directly above or obliquely above the second feature, or simply indicate that the first feature is horizontally higher than the second feature. A first feature being “under”, “below” or “underneath” a second feature may indicate the first feature being directly below and obliquely below the second feature, or simply indicate that the first feature is horizontally lower than the second feature.

In description of this specification, description with reference to terms such as “an embodiment”, “some embodiments”, “example”, “specific example”, or “some examples” means that a specific feature, structure, material or characteristic described in conjunction with the embodiment or example is included in at least one embodiment or example of the present disclosure. In this specification, illustrative expressions of the above terms are not necessarily directed to the same embodiment or example. Moreover, the specific feature, structure, material or characteristic described may be combined in a suitable manner in any one or more embodiments or examples. In addition, those skilled in the art may combine and merge different embodiments or examples described in this specification and features in the different embodiments or examples without mutual conflicts.

Described above are only specific embodiments of the present disclosure, but the protection scope of the present disclosure is not limited thereto, and all changes or substitutions that are easily conceivable by those skilled in the art within the technical scope of the present disclosure should be encompassed within the protection scope of the present disclosure. Thus, the protection scope of the present disclosure should be defined by the claims.

1. A centrifugal fan impeller, comprising blades and a fixing disk, the blades being forward-curved structures and fixed to the fixing disk, wherein in a height direction of the blades, widths of all or part of the blades progressively increase from a suction port to the fixing disk.

2. The centrifugal fan impeller according to claim 1, wherein intake sides of some or all of the blades are arranged inclined relative to an axial direction of the fixing disk.

3. The centrifugal fan impeller according to claim 2, wherein the inclinations of the intake sides of the blades relative to the axial direction of the fixing disk are set differently or identically.

4. The centrifugal fan impeller according to claim 1, wherein in the height direction of the blades, intake angles of the blades change continuously from the suction port towards the fixing disk.

5. The centrifugal fan impeller according to claim 4, wherein the intake angles of the blades continuously increase.

6. The centrifugal fan impeller according to claim 4, wherein a maximum value φ2 of the intake angles of the blades is: φ2=φ1+H×Y, where φ1 is a minimum value of the intake angles of the blades, H is a height of the blades, and Y is a second coefficient, wherein 1 degree/mm≥Y≥0.04 degree/mm, and optionally,
a range of the second coefficient Y is 0.2 degree/mm≤Y≤0.5 degree/mm.

7. (canceled)

8. The centrifugal fan impeller according to claim 1, wherein a diameter D1 of a maximum inscribed circle of the suction port of the centrifugal fan impeller perpendicular to an axis is: D1=D2+H×X, where D2 is a diameter of a minimum inscribed circle of the suction port of the centrifugal fan impeller perpendicular to the axis, H is the height of the blades, and X is a first coefficient, wherein 0.35≥X≥0.02, and optionally,
a range of the first coefficient X is 0.07≤X≤0.2.

9. (canceled)

10. The centrifugal fan impeller according to claim 1, wherein outlet angles β of the blades are in the range of: 5°≤β≤40°, and optionally
the outlet angles β of the blades (1) are in the range of 13°≤β≤24°.

11. (canceled)

12. The centrifugal fan impeller according to claim 1, wherein the centrifugal fan impeller is a structure with blades on one side or a structure with blades on two sides, wherein in the case of a structure with blades on two sides, the blades on the two sides are staggered.

13. The centrifugal fan impeller according to claim 1, further comprising second blades provided on the fixing disk and located on an inner side of the blades.

14. The centrifugal fan impeller according to claim 1, further comprising a reinforcing ring located at an end of an outlet side of the blades, the reinforcing ring being ring-like.

15. A fan for an air conditioning system, comprising a volute and the centrifugal fan impeller of claim 1, wherein the volute is configured to collect and direct an outflow from the centrifugal fan impeller and then discharge the outflow via an outflow port.

16. The fan according to claim 15, wherein the volute is a structure inclined on one side or a structure inclined on two sides.

17. The fan according to claim 16, wherein in the case where the volute is a structure inclined on one side, 0.7≤L1/L2≤0.99; and in the case where the volute is a structure inclined on two sides, 0.6≤L1/L2≤0.98, where L1 is a minimum distance between the two sides of the volute, and L2 is a maximum distance between the two sides of the volute.

18. The fan according to claim 17, wherein two endpoints of the minimum distance L1 on the two sides of the volute are located in an obtuse-angle sector area formed by three elements: a volute tongue, a circle center of an inflow port of the volute and a tail end of an involute of the volute; and two endpoints of the maximum distance L2 on the two sides of the volute are located in a sector area formed by three elements: the tail end of the involute of the volute, the circle center of the inflow port of the volute, and a distal end of the outflow port on the side of the volute tongue.

19. The fan according to claim 15, wherein the volute tongue of the volute is a flat volute tongue or an inclined volute tongue; in the case where the volute tongue is a flat volute tongue, a length direction of the volute tongue is parallel to an axial direction of the centrifugal fan impeller; and in the case where the volute tongue is an inclined volute tongue, an angle is formed between the length direction of the volute tongue and the axial direction of the centrifugal fan impeller.

20. The fan according to claim 19, wherein the volute tongue is a structure inclined on one side or a structure inclined on two sides.

21. The fan according to claim 15, wherein the volute is a one-piece structure or a split structure, and in the case where the volute is a split structure composed of a plurality of units of the volute, neighboring units of the volute are connected to each other in a limiting locking manner.

22. The fan according to claim 15, wherein the volute is provided with a partial removal portion.

23. An air conditioning system, comprising the fan of claim 15.
